(19) United States
(12) Patent Application Publication
(10) Pub. No.: US 2025/0308255 A1
(43) Pub. Date: Oct. 2, 2025

(54) CONTROL DEVICE AND METHOD FOR DETERMINING PARKING SPACE

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Suguru SAKAI, Tokyo (JP); Kazuhisa HASHIMOTO, Tokyo (JP); Yuta HIRANO, Tokyo (JP); Masashi OISHI, Owariasahi-shi (JP)

(21) Appl. No.: 19/089,780

(22) Filed: Mar. 25, 2025

(30) Foreign Application Priority Data
Mar. 27, 2024 (JP) 2024-051273

(51) Int. Cl. G06V 20/58; G08G 1/14

(52) U.S. Cl. CPC G06V 20/586; G08G 1/14

(57) ABSTRACT

A control device includes an image acquisition unit configured to acquire surrounding images that are images of surroundings of a host vehicle, a parking space candidate detection unit configured to detect, from the surrounding images, a parking space candidate that is an area likely to be a parking space, and a parking space determination unit configured to determine whether the parking space candidate is a parking space and a likelihood of the parking space candidate being a parking space, based on the surrounding images and predefined criteria. The criteria include at least one criterion with respect to a shape or position of the parking space candidate detected in the surrounding images, and at least one criterion with respect to an indicator or object present around the parking space candidate.

### CROSS-REFERENCE TO RELATED APPLICATION

This application is based on and claims the benefit of priority from earlier Japanese Patent Application No. 2024-051273 filed Mar. 27, 2024, the description of which is incorporated herein by reference.

### BACKGROUND

### Technical Field

This disclosure relates to a control device and a method for determining a parking space.

### Related Art

A vehicle control device is known that determines whether a host vehicle is in a parking lot based on the degree of confidence that the host vehicle is in the parking lot, where the host vehicle a vehicle to which the vehicle control device mounted. The degree of confidence is determined based on a relative position between the host vehicle and the parking space around the host vehicle, detected based on image data of surroundings of the host vehicle.

### BRIEF DESCRIPTION OF THE DRAWINGS

In the accompanying drawings:

FIG. 1 is a schematic diagram of a control device;

FIG. 2 is an example of a parking slot candidate;

FIG. 3 is an example of a parking slot candidate;

FIG. 4 is an example of a parking slot candidate;

FIG. 5 is an example of a parking space candidate;

FIG. 6 is a flowchart of an acceleration suppression process;

FIG. 7 is a flowchart of a parking space candidate determination process;

FIG. 8 is a flowchart of an acceleration suppression process;

FIG. 9 is an illustration of Condition A;

FIG. 10 is an illustration of Condition A;

FIG. 11 is an illustration of Condition D;

FIG. 12 is an illustration of Condition E;

FIG. 13 is an illustration of Condition F;

FIG. 14 is an illustration of Condition H;

FIG. 15 is an example of a relative position between a host vehicle and a determined parking space;

FIG. 16 is an example of a relative position between a host vehicle and a determined parking space;

FIG. 17 is an example of a relative position between a host vehicle and a determined parking space; and

FIG. 18 is a flowchart of an acceleration suppression process according to a second embodiment.

### DESCRIPTION OF SPECIFIC EMBODIMENTS

The above known vehicle control device, as disclosed in JP 2023-162881 A, detects a parking space around the host vehicle using captured images of the surroundings of the host vehicle. However, there is an issue with the above known vehicle control device that it may erroneously detect an area that is not a parking space as an actual parking space. In view of the foregoing, it is desired to have a technology for accurately determining whether an area around the host vehicle that may be a parking space is an actual parking space.

One aspect of the present disclosure provides a control device including: an image acquisition unit configured to acquire surrounding images that are images of surroundings of a host vehicle; a parking space candidate detection unit configured to detect, from the surrounding images, a parking space candidate that is an area likely to be a parking space; and a parking space determination unit configured to determine whether the parking space candidate is a parking space and a likelihood of the parking space candidate being a parking space, based on the surrounding images and predefined criteria. The criteria include at least one criterion with respect to a shape or position of the parking space candidate detected in the surrounding images, and at least one criterion with respect to an indicator or object present around the parking space candidate.

This configuration can provide an accurate determination as to whether an area around the host vehicle that is likely to be a parking space is a parking space.

In addition to the control device configured as above, the present disclosure may be embodied in various forms, such as a method for determining a parking space, a computer program, a non-transitory computer-readable storage medium, and a vehicle.

### A. First Embodiment

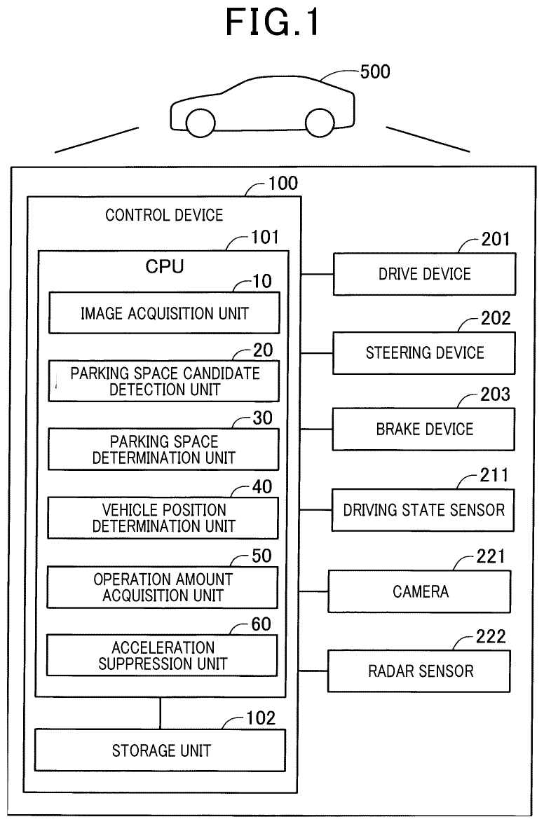

A control device 100 illustrated in FIG. 1 is mounted to a vehicle 500. The control device 100 is communicatively connected to a drive device 201, a steering device 202, a brake device 203, a driving state sensor 211, a camera 221, and a radar sensor 222 mounted to the vehicle 500. The vehicle 500 may be a hybrid electric vehicle (HEV), a plug-in hybrid electric vehicle (PHEV), a fuel cell electric vehicle (FCEV), a battery electric vehicle (BEV), or an engined vehicle. Hereinafter, the vehicle 500 to which the control device 100 is mounted is also referred to as a host vehicle.

The drive device 201 generates a drive force that is transmitted to the drive wheels of the vehicle 500. The drive device 201 is, for example, an electric motor or an engine.

The steering device 202 applies a turn force to the wheels of the vehicle 500. The steering device 202 is, for example, an electric power steering device.

The brake device 203 applies a brake force to the wheels of the vehicle 500. The brake device 203 is, for example, a disc brake device.

The driving state sensor 211 is a sensor that detects information on the driving state of the vehicle 500. The driving state sensor 211 includes, for example, a vehicle speed sensor, an accelerator sensor, a brake sensor, a steering angle sensor, and a turn signal switch. The driving state sensor 211 detects a speed of the vehicle 500, an operation amount of the accelerator pedal, an operation amount of the brake pedal, a steering angle of the steering wheel, an actuation status of the turn signal, and transmits information on the detected driving state of the vehicle 500 to the control device 100.

The camera 221 captures images of the surroundings of the vehicle 500. The images may be still images or moving images. The camera 221 captures at least images forward of the vehicle 500. In some cases, the vehicle 500 may be equipped with a plurality of cameras 221 for capturing images not only forward of the vehicle 500, but also in the left and right directions and behind the vehicle. The camera 221 transmits image data to the control device 100.

The radar sensor 222 detects objects around the vehicle 500. The radar sensor 222 emits electromagnetic waves to the surroundings of the vehicle 500 and receives reflected waves from objects around the vehicle 500 to detect the distance, angle, and relative speed of each object to the vehicle 500. The radar sensor 222 may include a millimeter-wave radar device or Light Detection and Ranging (LiDAR). The radar sensor 222 transmits detected distances, angles, and other information to the control device 100.

The control device 100 is configured as a computer that includes a CPU 101 and a storage unit 102. Specifically, the control device 100 is configured as an Electronic Control Unit (ECU). The storage unit 102 is configured as including a ROM, a RAM, a hard disk drive, or the like. The storage unit 102 stores various programs for controlling the operation of the control device 100. The CPU 101 functions as an image acquisition unit 10, a parking space candidate detection unit 20, a parking space determination unit 30, a vehicle position determination unit 40, an operation amount acquisition unit 50, and an acceleration suppression unit 60 by executing the programs stored in the storage unit 102. Alternatively, the control device 100 may be implemented by combining multiple circuits to implement at least part of each function, instead of being implemented by a computer.

The image acquisition unit 10 acquires images of the surroundings of the host vehicle. Specifically, the image acquisition unit 10 acquires image data transmitted from the camera 221. Hereinafter, the images of the surroundings of the host vehicle are also referred to as surrounding images.

The parking space candidate detection unit 20 detects a parking space candidate which is an area likely to be a parking space, from the surrounding images. In the present embodiment, the parking space candidate is an area consisting of two or more laterally consecutive parking slot candidates, where each parking slot candidate is likely to be a parking slot. The parking slot is a parking area for one vehicle 500.

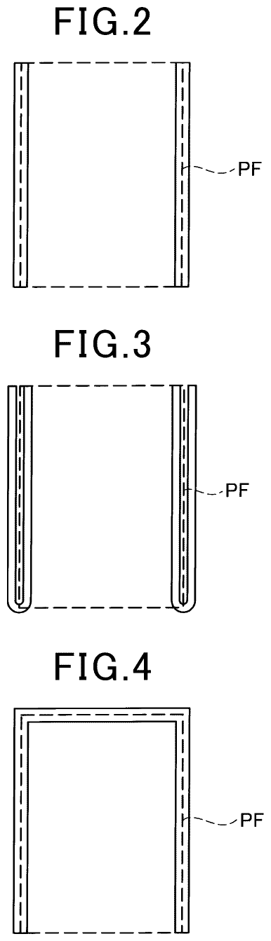

The parking slot candidates PF will now be described using FIGS. 2 to 4. FIGS. 2 to 4 illustrate a bird's-eye view of lines drawn on the road surface. Each parking slot candidate PF is an area defined by the lines drawn on the road surface. In the example illustrated in FIG. 2, two parallel lines are drawn on the road surface. The parking slot candidate PF illustrated in FIG. 2 is an area between two parallel lines, that is, an area defined only by two parallel lines. In the example illustrated in FIG. 3, two elongated U-shaped lines are drawn on the road surface. The parking slot candidate PF illustrated in FIG. 3 is an area between the two U-shaped lines. In the example illustrated in FIG. 4, a rectangular-shaped line lacking one short side is drawn on the road surface. The parking slot candidate PF illustrated in FIG. 4 is the area inside the rectangle lacking one short side. The parking slot candidate PF may not be limited to any example described above, but may be an area inside a rectangle drawn on the road surface, or an area between two parallel double lines. The parking space candidate detection unit 20 recognizes the parking slot candidates PF included in the surrounding images using a machine learning model that has been pre-learned using images with parking slots captured therein. In the machine learning model, for example, a convolutional neural network is used as an algorithm. Alternatively, the parking space candidate detection unit 20 may recognize parking slot candidates PF included in the surrounding images using techniques such as the pattern matching and edge detection.

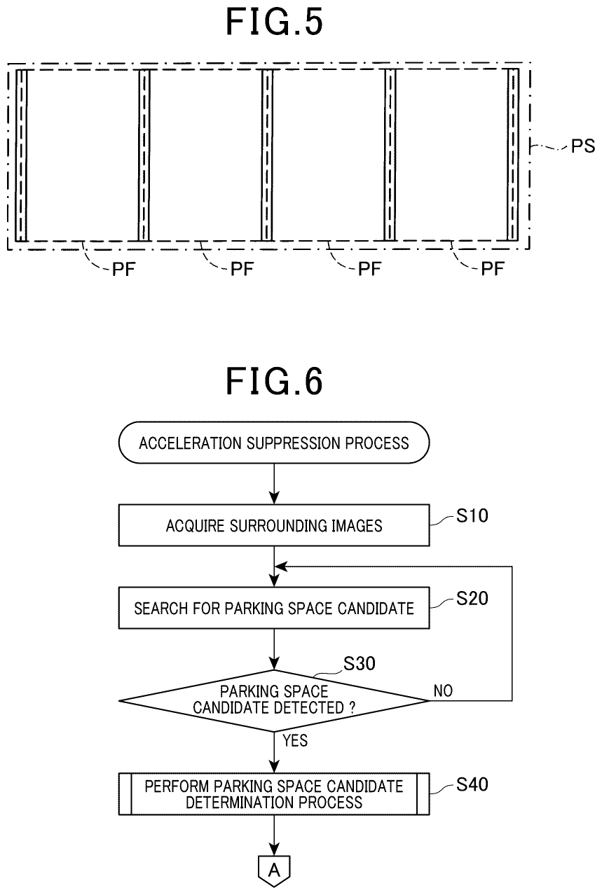

The parking space candidate PS will now be described with reference to FIG. 5. As illustrated in FIG. 5, the parking space candidate PS is an area consisting of two or more laterally consecutive parking slot candidates PF. Here, the laterally consecutive parking slot candidates PF means that a distance between laterally adjacent parking slot candidates PF is less than a predefined lateral side-by-side distance. In this specification, the lateral direction of the parking slot candidate PF refers to a direction of the short side of the parking slot candidate PF, and the longitudinal direction of the parking slot candidate PF refers to a direction of the long side of the parking slot candidate PF. In addition, the lateral direction of the parking space candidate PS refers to a direction parallel to the lateral direction of the parking slot candidates PF included in that parking space candidate PS, and the longitudinal direction of the parking space candidate PS refers to a direction parallel to the longitudinal direction of the parking slot candidates PF included in that parking space candidate PS. The parking space candidate PS of the present embodiment is also referred to as a parking row.

The parking space determination unit 30 determines whether the parking space candidate PS detected by the parking space candidate detection unit 20 is a parking space, and the likelihood of the parking space candidate PS detected by the parking space candidate detection unit 20 being a parking space, based on the surrounding images and predefined criteria. The criteria include at least one criterion with respect to a shape or position of the parking space candidate PS detected in the surrounding images, and at least one criterion with respect to an indicator or object present around the parking space candidate PS. The details of the criterion will be described later.

The vehicle position determination unit 40 determines whether the host vehicle is present in a parking lot or whether a parking lot is present in the travel direction of the host vehicle based on the relative position between the host vehicle and the parking space candidate PS that has been determined to be a parking space by the parking space determination unit 30.

The operation amount acquisition unit 50 acquires an operation amount of an acceleration control. The acceleration control is, for example, an accelerator pedal, and the operation amount of the acceleration control is, for example, an amount of depression of the accelerator pedal. The operation amount acquisition unit 50 acquires, for example, the amount of depression of the accelerator pedal detected by the accelerator sensor included in the driving state sensor 211.

The acceleration suppression unit 60 suppresses the acceleration of the host vehicle caused by the operation of the acceleration control when the operation amount of the acceleration control is greater than or equal to a predefined threshold value.

When the host vehicle is traveling at a speed lower than or equal to a predefined speed or is stationary, the control device 100 repeatedly performs an acceleration suppression process illustrated in FIGS. 6 to 8 every predefined cycle. The acceleration suppression process will now be described with reference to FIGS. 6 to 8.

At step S10 in FIG. 6, the image acquisition unit 10 acquires a surrounding image. Step S10 is also referred to as an image acquisition step.

At step S20, the parking space candidate detection unit 20 searches for a parking space candidate PS included in the surrounding image. Step S20 is also referred to as a parking space candidate detection step.

At step S30, the parking space candidate detection unit 20 determines whether a parking space candidate PS has been detected in the surrounding image. If a parking space candidate PS has been detected, the process flow proceeds to step S40. If no parking space candidate PS has been detected, the process flow returns to step S20.

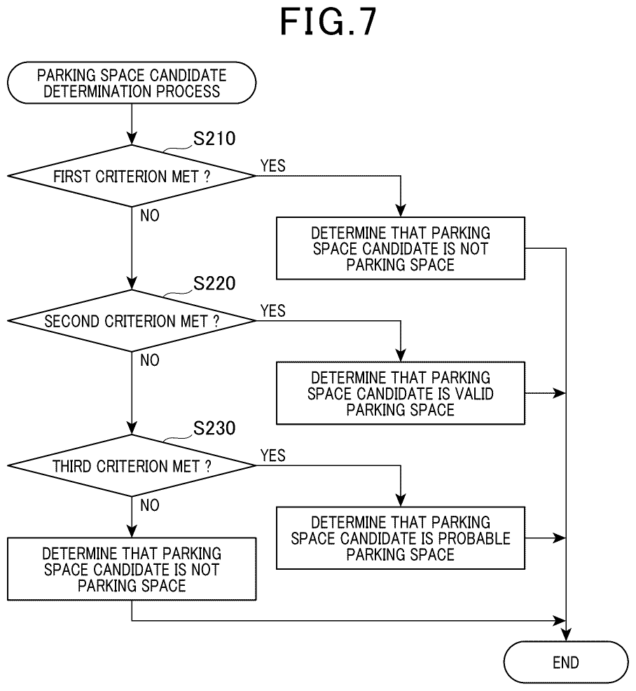

At step S40, the parking space determination unit 30 performs the parking space candidate determination process illustrated in FIG. 7. The parking space candidate determination process is a process of determining whether a parking space candidate PS is a parking space and the likelihood of the parking space candidate PS being a parking space based on the criteria. The criteria include a first criterion, a second criterion, and a third criterion described later. Step S40 is also referred to as the parking space determination step.

At step S210 in FIG. 7, the parking space determination unit 30 determines whether the first criterion is met. Meeting of the first criterion means that the following condition A or B is met. If the first criterion is met, the parking space determination unit 30 determines that the parking space candidate PS is not a parking space. In this specification, the parking space candidate PS that is determined not to be a parking space is also referred to as an invalid parking space. If the first criterion is not met, the process flow proceeds to step S220.

Condition A: The parking space candidate PS is determined to be present on a public road based on information about indicators or objects around the parking space candidate PS.

Condition B: Another vehicle passes through the parking space candidate PS at a speed higher than or equal to a predefined speed.

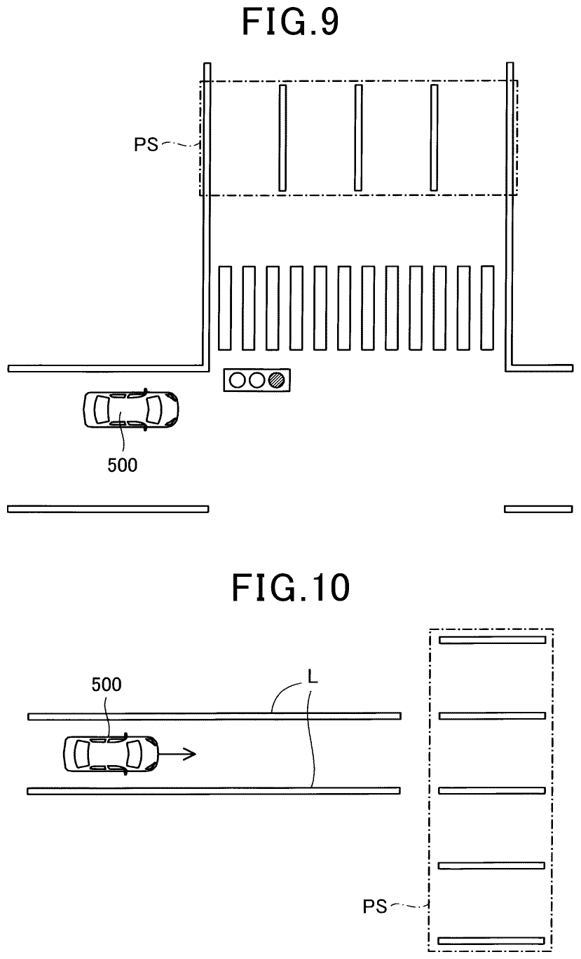

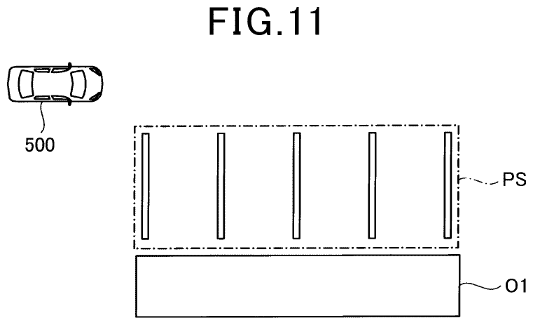

Condition A will now be described. If the parking space candidate detection unit 20 detects a traffic light or a pedestrian crossing in the surrounding image, the parking space candidate detection unit 20 determines that the area around the traffic light and pedestrian crossing is an intersection. If the parking space candidate PS is present around an intersection, the parking space determination unit 30 determines that the parking space candidate PS is present on a public road. For example, if the intersection and the parking space candidate PS are located as illustrated in FIG. 9, the parking space determination unit 30 determines that the parking space candidate PS is present on a public road. In addition to the surroundings images, information acquired by the radar sensor 222 may be used to detect objects such as traffic lights. As illustrated in FIG. 10, if the parking space candidate PS intersects with the demarcation lines L that define a lane in which the host vehicle is traveling, the parking space determination unit 30 determines that the parking space candidate PS is present on a public road.

Condition A includes a criterion with respect to the position of the parking space candidate PS and a criterion with respect to indicators or objects present around the parking space candidate PS.

Condition B will now be described. Whether another vehicle has passed through the parking space candidate PS is determined using information acquired by the camera 221 and radar sensor 222. The predefined speed in Condition B is preferably higher than or equal to 20 km/h.

Condition B is a criterion with respect to objects around the parking space candidate PS.

At step S220 in FIG. 7, the parking space determination unit 30 determines whether the second criterion is met. Meeting of the second criterion means that at least one of the following conditions C to F is not met. If the second criterion is met, the parking space determination unit 30 determines that the parking space candidate PS is a valid parking space. The valid parking space is a parking space candidate PS highly likely to be a parking space. If the second criterion is not met, the process flow proceeds to step S230.

Condition C: Each parking slot candidate PF included in the parking space candidate PS is an area defined by only two parallel lines.

Condition D: There is no object adjacent to the parking space candidate PS in the longitudinal direction of the parking space candidate PS.

Condition E: The lateral length of the parking space candidate PS is less than a predefined first length, or the lateral length of a merged area of the parking space candidate PS and a parking space candidate PS laterally adjacent thereto is less than a predefined second length.

Condition F: In the longitudinal direction of the parking space candidate PS, there is no other parking space candidate PS at a distance less than a predefined distance.

Condition C will now be described. Not meeting Condition C means that each parking slot candidate PF included in the parking space candidate PS is not an area defined by only two parallel lines as illustrated in FIG. 2. That is, it means that each parking slot candidate PF included in the parking space candidate PS is not an area between two U-shaped lines as illustrated in FIG. 3, an area inside a rectangle lacking one short side as illustrated in FIG. 4, an area inside a rectangle drawn on the road surface, or an area between two double lines that are parallel to each other. Condition C is a criterion with respect to the shape of the parking space candidate PS.

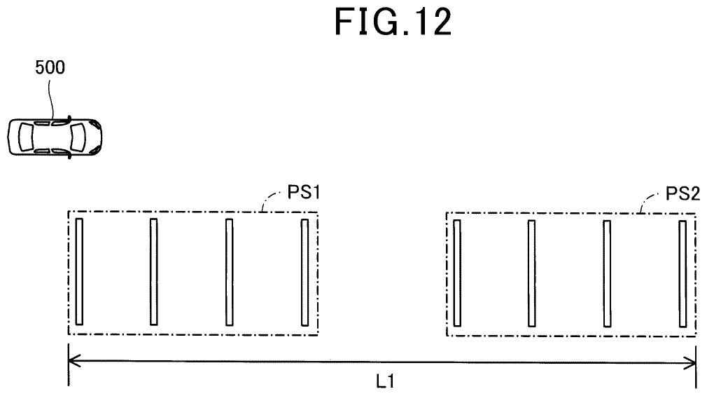

Condition D will now be described. FIG. 11 illustrates an example of an object O1 adjacent to a parking space candidate PS in the longitudinal direction of the parking space candidate PS. The object O1 is, for example, a wall, a curb, a fence, or a hedge. Not meeting Condition D means that there is an object O1 as illustrated in FIG. 11. In the example illustrated in FIG. 11, the length of the object O1 in the lateral direction is equal to the length of the parking space candidate PS in the lateral direction, but the length of the object O1 in the lateral direction may be less than the length of the parking space candidate PS in the lateral direction. Condition D is a criterion with respect to objects around the parking space candidate PS.

Condition E will now be described. Not meeting Condition E means that the length of the parking space candidate PS in the lateral direction is greater than a first length, and that the length of the area encompassing the parking space candidate PS and another parking space candidate PS adjacent thereto in the lateral direction is greater than a second length. For example, as illustrated in FIG. 12, when there are parking space candidates PS1 and PS2, the “length of the area encompassing the parking space candidate PS and another parking space candidate PS adjacent thereto in the lateral direction” is the length L1 shown in FIG. 12. The parking space candidates PS1 and PS2 illustrated in FIG. 12 are separated by a lateral side-by-side distance or more. The first length is preferably greater than or equal to 5 meters. The second length is preferably greater than or equal to 10 meters. Condition E is a criterion with respect to shapes or positions of the parking space candidates PS.

Condition F will now be described. Not meeting Condition F means that there is another parking space candidate PS in the longitudinal direction of the parking space candidate PS, at a distance less than a predefined distance. FIG. 13 illustrates a situation where there is another parking space candidate PS4 in the longitudinal direction of parking space candidate PS3. Not meeting Condition F means that the distance L2, which is a longitudinal direction distance between the parking space candidate PS3 and the parking space candidate PS4, is less than a predefined longitudinal side-by-side distance. The longitudinal side-by-side distance is less than or equal to 2 meters. Condition F is a criterion with respect to positions of the parking space candidates PS.

At step S230 in FIG. 7, the parking space determination unit 30 determines whether the third criterion is met. Meeting of the third criterion means that the following conditions G and H are met. If the third criterion is met, the parking space determination unit 30 determines that the parking space candidate PS is a probable parking space. The probable parking space is a parking space candidate PS that is less likely to be a parking space than the valid parking space. If the third criterion is not met, the parking space determination unit 30 determines that parking space candidate PS is not a parking space. The parking space candidate determination process is performed as described above. Condition G: There is a stationary other vehicle at a distance from the parking space candidate PS that is less than a predefined distance.

Condition H: The angle between the longitudinal direction of the parking space candidate PS and the travel direction of the host vehicle is greater than or equal to a predefined angle.

Condition G will now be described. The predefined distance in Condition G is preferably less than or equal to 5 meters. Condition G is also met if another vehicle is stationary in one of the parking slot candidates PF included in the parking space candidate PS.

Condition G is a condition regarding objects around the parking space candidate PS.

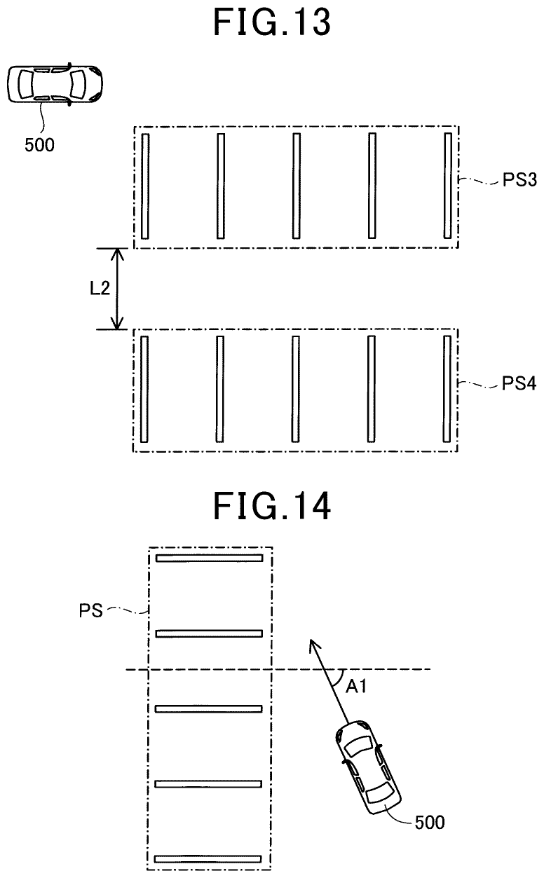

Condition H will now be described. FIG. 14 illustrates a situation where the host vehicle is traveling in the vicinity of the parking space candidate PS. In FIG. 14, the travel direction of the host vehicle is indicated by an arrow. The “angle between the longitudinal direction of the parking space candidate and the travel direction of the host vehicle” is the angle A1 indicated in FIG. 14. The predefined angle in Condition H is preferably greater than or equal to 30 degrees. Condition His a condition regarding the position of the parking space candidate PS.

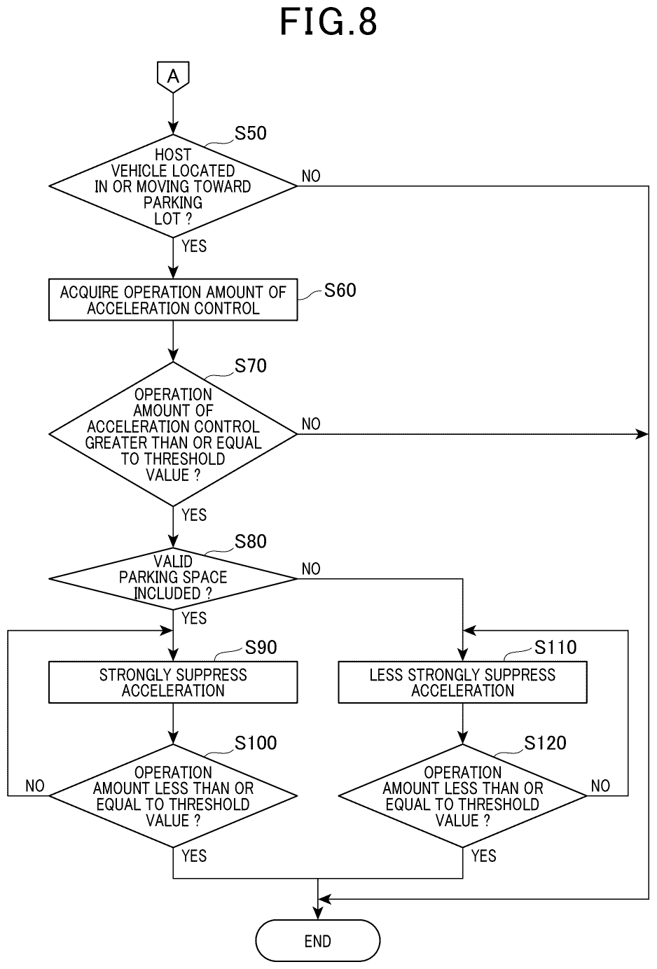

At step S50 in FIG. 8, the vehicle position determination unit 40 determines whether the host vehicle is present in a parking lot or whether a parking lot is present in the travel direction of the host vehicle. If it is determined that the host vehicle is located in a parking lot or that there is a parking lot in the travel direction of the host vehicle, the process flow proceeds to step S60. If it is determined that the host vehicle is not located in a parking lot and there is no parking lot in the travel direction of the vehicle, the control device 100 terminates the acceleration suppression process.

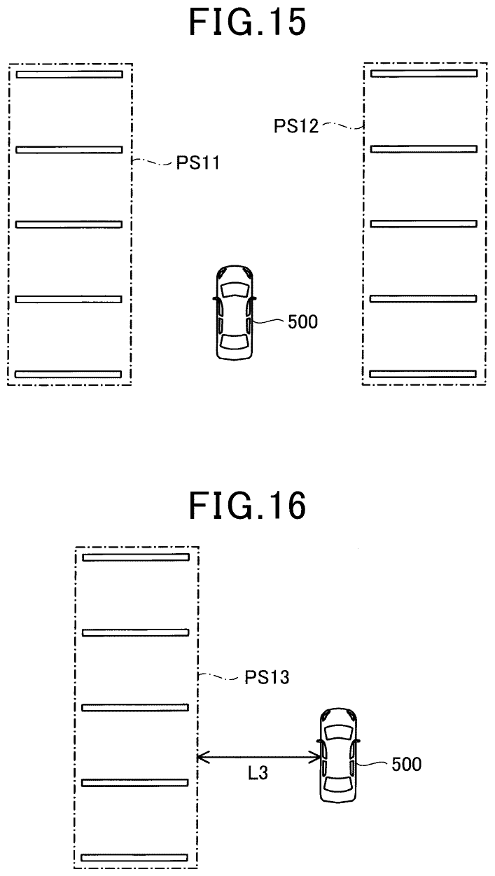

The vehicle position determination unit 40 determines that the host vehicle is located in a parking lot, for example, in a case where there is a valid parking space or probable parking space on each side of the host vehicle, or in a case where there is a valid parking space or probable parking space at a distance less than or equal to a predefined distance on one side of the host vehicle. Hereinafter, the valid parking spaces and the probable parking spaces are collectively referred to as determined parking spaces. For example, in a case where the host vehicle and the determined parking spaces PS11 and PS12 are in the positions illustrated in FIG. 15, the vehicle position determination unit 40 determines that the host vehicle is in a parking lot. In a case where the host vehicle and the determined parking space PS13 are in the positions illustrated in FIG. 16, and the distance L3 between the host vehicle and the determined parking space PS13 is less than the predefined distance, the vehicle position determination unit 40 determines that the host vehicle is in a parking lot.

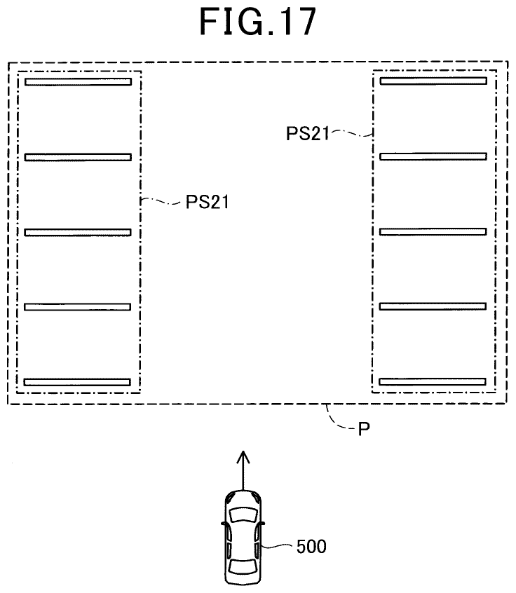

The vehicle position determination unit 40 determines that an area including a plurality of determined parking spaces PS21, as illustrated in FIG. 17, is a parking lot P. The vehicle position determination unit 40 determines that there is a parking lot P in the travel direction of the host vehicle when the host vehicle is moving toward the parking lot P. Whether the host vehicle is moving toward the parking lot P is determined using the vehicle speed acquired by the vehicle speed sensor and the steering angle acquired by the steering angle sensor.

At step S60 in FIG. 8, the operation amount acquisition unit 50 acquires an operation amount of the acceleration control.

At step S70, the control device 100 determines whether the operation amount of the acceleration control acquired by the operation amount acquisition unit 50 at step S60 is greater than or equal to a predefined threshold value. For example, the control device 100 determines whether the amount of acceleration pedal depression detected by the accelerator sensor is greater than or equal to a predefined threshold value. If it is determined that the operation amount of the acceleration control is greater than or equal to the predefined threshold value, the process flow proceeds to step S80. If it is determined that the operation amount of the acceleration control is less than the predefined threshold value, the control device 110 terminates the acceleration suppression process.

At step S80, the control device 100 determines whether the parking lot where the host vehicle is located or the parking lot in the travel direction of the vehicle is formed of valid parking spaces. If the parking lot is formed as including at least one valid parking space, the process flow proceeds to step S90. If the parking lot is formed as including no valid parking spaces, that is, if the parking lot is formed only of probable parking spaces, the process flow proceeds to step S110. In some embodiments, if the parking lot does not include any probable parking spaces, that is, if the parking lot is formed only of valid parking spaces, the process flow may proceed to step S90, and if the parking lot includes at least one probable parking space, the process flow may proceed to step S110.

At step S90, the acceleration suppression unit 60 strongly suppresses the acceleration of the host vehicle caused by the operation of the acceleration control. The acceleration suppression unit 60 controls the operation of the drive device 201 so that the acceleration of the host vehicle 500 does not increase even if the accelerator pedal is depressed. In some embodiments, when the accelerator pedal is depressed, the acceleration suppression unit 60 may control the operation of the drive device 201 so that the acceleration of the host vehicle 500 increases by about 10% of a reference value, where the reference value is an amount of increase in acceleration of the vehicle 500 that is predetermined for the operation amount of the accelerator pedal.

At step S100, the control device 100 determines whether the operation amount of the acceleration control has fallen below a predefined threshold value. For example, the control device 100 determines whether the amount of acceleration pedal depression detected by the accelerator sensor is below a predefined threshold value. If it is determined that the operation amount of the acceleration control has fallen below the predefined threshold value, the control device 100 terminates the acceleration suppression process. If it is determined that the operation amount of the acceleration control is not below the predefined threshold value, the process flow returns to step S90.

At step S110, the acceleration suppression unit 60 suppresses the acceleration of the host vehicle caused by operation of the acceleration control to a weaker degree than when the parking lot is formed as including at least one valid parking space. When the accelerator pedal is depressed, the acceleration suppression unit 60 is preferably configured to control the actuation of the drive device 201 so that the acceleration of the host vehicle increases by approximately 10% to 20% of the reference value that is the predetermined amount of increase in acceleration of the vehicle 500 for the operation amount of the accelerator pedal. In some embodiments, when the accelerator pedal is depressed, the acceleration suppression unit 60 may control the actuation of the drive device 201 so that the acceleration of the host vehicle 500 increases by about 10% to 50% of the reference value.

At step S120, the control device 100 determines whether the operation amount of the acceleration control has fallen below a predefined threshold value. For example, the control device 100 determines whether the amount of acceleration pedal depression detected by the accelerator sensor has fallen below the predefined threshold value. If it is determined that the operation amount of the acceleration control has fallen below the predefined threshold value, the control device 100 terminates the acceleration suppression process. If it is determined that the operation amount of the acceleration control is not below the predefined threshold value, the process flow returns to step S110. As described above, the acceleration control process is performed.

According to the first embodiment described above, the parking space determination unit 30 determines whether the parking space candidate PS is a parking space and the likelihood of the parking space candidate PS being a parking space based on the surrounding images and the criteria. The criteria include a criterion with respect to a shape or position of the parking space candidate PS, and a criterion with respect to an indicator or object present around the parking space candidate PS. This allows a determination as to whether an area around the host vehicle that is likely to be a parking space is a parking space to be made accurately.

In the present embodiment, when the first criterion is met, the parking space determination unit 30 determines that the parking space candidate PS is not a parking space. Meeting of the first criterion means that the condition A or condition B described above is met. In the above-mentioned example, when there is a parking space candidate PS around an intersection, the parking space determination unit 30 determines that the parking space candidate PS is present on a public road. In the case where there is a parking space candidate PS around an intersection, the area defined by the lane markings may be misidentified as a parking space candidate PS. Also, in the case where another vehicle passes through a parking space candidate PS at a speed higher than the predetermined speed, the area defined by the lane markings may be misidentified as a parking space candidate PS. Therefore, determining when the first condition is met that the parking space candidate PS is not a parking space can reduce the possibility of misidentifying an area that is not a parking space as a parking space.

In the present embodiment, the parking space determination unit 30 determines that a parking space candidate PS is a valid parking space when the first criterion is not met and the second criterion is met. Meeting of the second criterion means that at least one of the following conditions C to F is not met. First, in the case where a parking space candidate PS is an area defined by only two parallel lines, the area defined by the lane demarcation lines may be misidentified as a parking space candidate PS. In addition, in the case where a parking space candidate PS is a parking space, it is highly likely that there are objects such as walls or curbs adjacent to the parking space candidate PS in the longitudinal direction of the parking space candidate PS. Therefore, in the case where there are no objects adjacent to the parking space candidate PS in the longitudinal direction, the area defined by the lane demarcation lines may be misidentified as a parking space candidate PS. In the case where a parking space candidate PS is a parking space, it is highly likely that there are a large number of consecutive parking slots in the lateral direction. That is, it is highly likely that the length of the parking space in the lateral direction is long. In the case where a parking space candidate PS is a parking space, it is highly likely that there are a plurality of parking spaces adjacent to it in the lateral direction. That is, the combined area of the parking space and the parking spaces adjacent to it in the lateral direction is likely to be long in the lateral direction. Therefore, in the case that the lateral length of a parking space candidate PS is less than the predetermined length, or the lateral length of the merged area of a parking space candidate PS and a parking space candidate PS adjacent thereto in the lateral direction is less than the predetermined length, the area that is not a parking space may be misidentified as a parking space candidate PS. In the case where the parking space candidate PS is a parking space, it is highly likely that there are other parking space candidates PS within a shorter distance than the predetermined distance in the longitudinal direction of the parking space candidate PS. In other words, it is highly likely that there are a plurality of consecutive parking space candidates PS in the longitudinal direction. Therefore, in the case that there are no other parking space candidate PS within a shorter distance than the predetermined distance in the longitudinal direction of a parking space candidate PS, an area that is not a parking space may be misidentified as a parking space candidate PS. Therefore, the possibility of misidentifying an area that is not a parking space or an area that is unlikely to be a parking space as a valid parking space can be reduced.

In the present embodiment, the parking space determination unit 30 determines that the parking space candidate PS is a probable parking space when the first condition is not met, the second condition is not met, and the third condition is met. The parking space determination unit 30 determines that parking space candidate PS is not a parking space when the first condition is not met, the second condition is not met, and the third condition is not met. Meeting of the third condition means that the conditions G and H described above are met. First, in a case where another vehicle is stationary at a distance from the parking space candidate PS less than a predetermined distance, the parking space candidate PS is likely to be a parking space. In the case where the area defined by the lane demarcation lines is misidentified as a parking space candidate PS and the host vehicle is traveling on a public road, the angle between the longitudinal direction of the parking space candidate PS and the travel direction of the vehicle is expected to be close to zero degrees. Therefore, in the case where the angle between the longitudinal direction of the parking space candidate PS and the travel direction of the host vehicle is greater than or equal to the predetermined angle, it is unlikely that the area defined by the lane demarcation lines is misidentified as the parking space candidate PS. Therefore, the possibility of misidentifying an area that is not a parking space as a probable parking space and the possibility of misidentifying an area that is a parking space as not a parking space can be reduced.

In the present embodiment, when it is determined that the host vehicle is located in a parking lot or that there is a parking lot in the travel direction of the host vehicle, and the operation amount of the acceleration control is greater than or equal to a predetermined threshold value, the acceleration suppression unit 60 suppresses the acceleration of the host vehicle by the operation of the acceleration control. Therefore, even if the driver depresses the accelerator pedal mistakenly for the brake pedal while the host vehicle is in the parking lot or the host vehicle is moving toward the parking lot, this can prevent the host vehicle from accelerating rapidly.

In the present embodiment, the acceleration suppression unit 60 strongly suppresses the acceleration of the host vehicle when the parking lot is formed as including at least one valid parking space and less strongly suppresses the acceleration of the host vehicle when the parking lot is formed only of probable parking spaces than when the parking lot is formed as including at least one valid parking space. Therefore, when the parking space candidate PS constituting a parking lot is likely to be a parking space, the acceleration of the host vehicle can be more strongly suppressed.

### B. Second Embodiment

A second embodiment will now be described with reference to the accompanying drawings, focusing on differences from the first embodiment. In the second embodiment, the contents of the acceleration suppression process differ from those in the first embodiment. The configuration of each part of the control device 100 in the second embodiment is the same as that in the first embodiment.

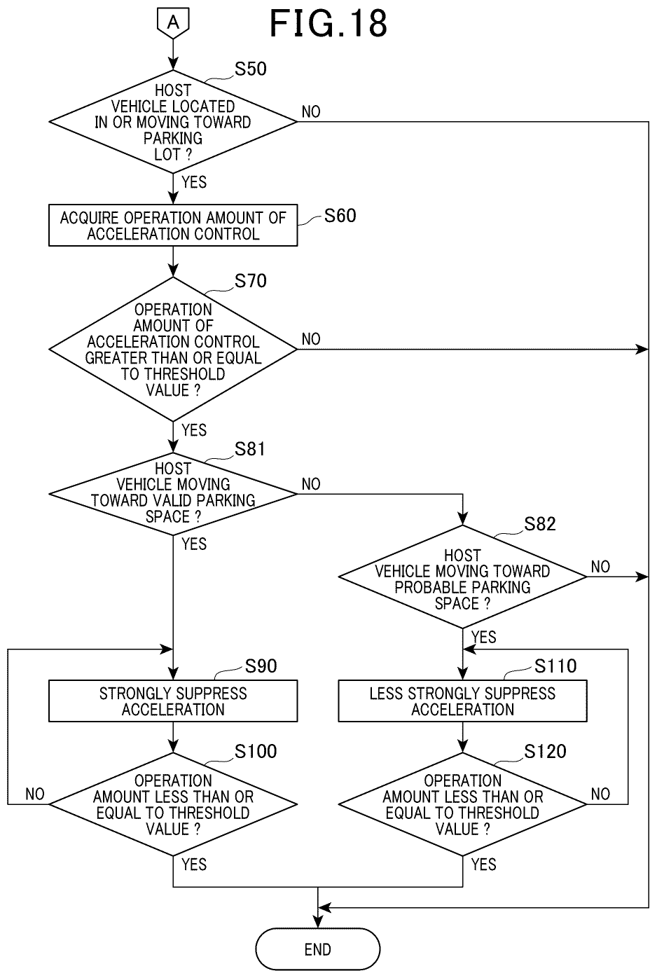

FIG. 18 is a flowchart illustrating portions of the acceleration suppression process in the second embodiment. Since steps S10 through S40 are performed in the same manner as in the first embodiment, these steps are omitted from the FIG. 18. The same portions of the acceleration suppression process performed as in the acceleration suppression process illustrated in FIG. 8 are assigned the same reference numbers and duplicated description thereof will be omitted.

At step S81, the control device 100 determines whether the host vehicle is moving toward a valid parking space. Whether or not the host vehicle is moving toward a valid parking space is determined using the relative position between the host vehicle and the valid parking space, the speed of the host vehicle acquired by the speed sensor, the steering angle acquired by the steering angle sensor, and other information. If the host vehicle is moving toward a valid parking space, the process flow proceeds to step S90. If the host vehicle is not moving toward a valid parking space, the process flow proceeds to step S82.

At step S82, the control device 100 determines whether the host vehicle is moving toward a probable parking space. Whether the host vehicle is moving toward a probable parking space is determined using the relative position between the host vehicle and the probable parking space, the speed of the host vehicle acquired by the speed sensor, the steering angle acquired by the steering angle sensor, and other information. If the host vehicle is moving toward a probable parking space, the process flow proceeds to step S110. If the host vehicle is not moving toward a probable parking space, the control device 100 terminates the acceleration suppression process.

According to the second embodiment described above, the acceleration suppression unit 60 strongly suppresses the acceleration of the host vehicle when the host vehicle is moving toward a valid parking space, and weakly suppresses the acceleration of the host vehicle when the host vehicle is moving toward a probable parking space than when the host vehicle is moving toward a valid parking space. Therefore, even if the driver depresses the accelerator pedal mistakenly for the brake pedal while the host vehicle is moving toward an area that is likely to be a parking space, the sudden acceleration of the host vehicle can be strongly suppressed. Even if the driver depresses the accelerator pedal mistakenly for the brake pedal while the host vehicle is moving toward an area that is less likely to be a parking space, the sudden acceleration of the host vehicle can be suppressed.

### C. Other Embodiments

(C-1) In the above embodiments, the parking space candidate PS is an area including two or more laterally consecutive parking slot candidates PF. In an alternative, the parking space candidate PS may be an area that is likely to be a parking slot. That is, the parking space candidate PS may be a single parking slot candidate PF. In this embodiment, a condition E is as follows. A third length is a predefined length that is preferably greater than or equal to 10 meters. Condition E: The lateral length of a merged area of a parking space candidate PS and a parking space candidate PS adjacent thereto in the lateral direction is less than the third length.

(C-2) In the above embodiments, the control device 100 includes the vehicle position determination unit 40, the operation amount acquisition unit 50, and the acceleration suppression unit 60. In an alternative, the control device 100 may not include the vehicle position determination unit 40, the operation amount acquisition unit 50, and the acceleration suppression unit 60.

(C-3) In the above embodiments, the parking space determination unit 30 determines that the parking space candidate PS is a probable parking space when the first criterion is not met, the second criterion is not met, and the third criterion is met. The parking space determination unit 30 determines that the parking space candidate PS is not a parking space when the first criterion is not met, the second criterion is not met, and the third criterion is not met. In an alternative, the parking space determination unit 30 may not determine whether the parking space candidate PS is a parking space and the likelihood of the parking space candidate PS being a parking space using the third condition. That is, step S230 in the parking space candidate determination process may not be performed.

(C-4) In the above embodiments, the parking space determination unit 30 determines that the parking space candidate PS is a valid parking space when the first criterion is not met and the second criterion is met. In an alternative, the parking space determination unit 30 may not determine the likelihood of the parking space candidate PS being a parking space using the second criterion. That is, step S220 in the parking space candidate determination process may not be performed.

(C-5) In the above embodiments, the parking space determination unit 30 determines that the parking space candidate PS is not a parking space when the first criterion is met. In an alternative, the parking space determination unit 30 may not determine whether the parking space candidate PS is a parking space using the first criterion. That is, step S210 in the parking space candidate determination process may not be performed.

(C-6) In the above embodiment, the criteria include the first criterion, the second criterion, and the third criterion. The criteria may not be limited to including the first criterion, the second criterion, and the third criterion. The criteria only have to include a criterion with respect to a shape or position of the parking space candidate PS detected in the surrounding images, and a criterion with respect to an indicator or object present around the parking space candidate PS.

(C-7) The control device 100 and the method thereof described in the present disclosure may be realized by a dedicated computer provided by configuring a processor and memory programmed to perform one or more functions embodied in a computer program. Alternatively, the control device 100 and the method thereof described in the present disclosure may be realized by a dedicated computer provided by configuring a processor with one or more dedicated hardware logic circuits. Alternatively, the control device 100 and the method thereof described in the present disclosure may be realized by one or more dedicated computers configured by a combination of a processor and memory programmed to perform one or more functions, and a processor configured with one or more hardware logic circuits. In addition, the computer program may be stored in a computer-readable, non-transitory tangible storage medium as instructions to be executed by a computer.

The present disclosure is not limited to any of the embodiments described above but may be implemented by a diversity of other configurations without departing from the scope of the disclosure. For example, the technical features of the embodiments corresponding to the technical features of the respective aspects may be replaced or combined appropriately, in order to solve some or all of the issues described above or in order to achieve some or all of the advantages described above. Any of the technical features may be omitted appropriately unless the technical feature is described as essential herein.

What is claimed is:

1. A control device comprising:
an image acquisition unit configured to acquire surrounding images that are images of surroundings of a host vehicle;
a parking space candidate detection unit configured to detect, from the surrounding images, a parking space candidate that is an area likely to be a parking space; and
a parking space determination unit configured to determine whether the parking space candidate is a parking space and a likelihood of the parking space candidate being a parking space, based on the surrounding images and predefined criteria, wherein
the predefined criteria include at least one criterion with respect to a shape or position of the parking space candidate detected in the surrounding images, and at least one criterion with respect to an indicator or object present around the parking space candidate.

2. The control device according to claim 1, wherein
the parking space determination unit is configured to determine that the parking space candidate is not a parking space when a first criterion of the predefined criteria is met,
the first criterion is met when a condition A or a condition B is met,
the condition A is that the parking space candidate is determined to be present on a public road based on information about the indicator or the object present around the parking space candidate, and
the condition B is that another vehicle passes through the parking space candidate at a speed higher than or equal to a predefined speed.

3. The control device according to claim 2, wherein
the parking space determination unit is configured to, when the first criterion is not met and a second criterion of the predefined criteria is met, determine that the parking space candidate is a valid parking space that is likely to be a parking space,
the second criterion is met when at least one of conditions C, D, E, and F is not met,
the condition C is that each parking slot candidate, which is likely to be a parking slot, included in the parking space candidate is an area defined by only two parallel lines,
the condition D is that there is no object adjacent to the parking space candidate in a longitudinal direction of the parking space candidate,
the condition E is that a lateral length of the parking space candidate including two or more parking slot candidates is less than a predefined length, or a lateral length of a merged area of the parking space candidate and a parking space candidate laterally adjacent thereto is less than a predefined second length, and
the condition F is that, in a longitudinal direction of the parking space candidate, there is no other parking space candidate at a distance less than a predefined distance.

4. The control device according to claim 3, wherein
the parking space determination unit is configured to determine that the parking space candidate is a probable parking space that is less likely to be a parking space than the valid parking space when the first criterion is not met, the second criterion is not met, and a third criterion of the predefined criteria is met, and determine that the parking space candidate is not a parking space when the first criterion is not met, the second criterion is not met, and the third criterion is not met,
the third criterion is met when conditions G and H are met,
the condition G is that there is a stationary other vehicle at a distance from the parking space candidate that is less than a predefined distance,
the condition H is that an angle between a longitudinal direction of the parking space candidate and a travel direction of the host vehicle is greater than or equal to a predefined angle.

5. The control device according to claim 4, further comprising:
a vehicle position determination unit configured to determine whether the host vehicle is present in a parking lot or whether a parking lot is present in the travel direction of the host vehicle based on a relative position between the host vehicle and the valid parking space or probable parking space;
an operation amount acquisition unit configured to acquire an operation amount of an acceleration control; and
an acceleration suppression unit configured to suppress an acceleration of the host vehicle caused by an operation of the acceleration control when the operation amount of the acceleration control is greater than or equal to a predefined threshold value, the acceleration suppression unit being configured to, when the vehicle position determination unit determines that the host vehicle is present in the parking lot or that the parking lot is present in the travel direction of the host vehicle, suppress the acceleration of the host vehicle.

6. The control device according to claim 5, wherein
the acceleration suppression unit is configured to strongly suppress the acceleration of the host vehicle when the parking lot is formed as including at least one valid parking space and less strongly suppress the acceleration of the host vehicle when the parking lot is formed only of the probable parking spaces than when the parking lot is formed as including at least one valid parking space.

7. The control device according to claim 5, wherein
the acceleration suppression unit is configured to strongly suppress the acceleration of the host vehicle when the host vehicle is moving toward the valid parking space, and less strongly suppress the acceleration of the host vehicle when the host vehicle is moving toward the probable parking space than when the host vehicle is moving toward the valid parking space.

8. The control device according to claim 1, wherein
the parking space candidate is an area including two or more laterally consecutive parking slot candidates each likely to be a parking slot.

9. The control device according to claim 1, wherein
the parking space candidate is an area likely to be a parking slot.

10. A method for determining a parking space, comprising:
acquiring surrounding images that are images of surroundings of a host vehicle;
detecting, from the surrounding images, a parking space candidate that is an area likely to be a parking space; and
determining whether the parking space candidate is a parking space and a likelihood of the parking space candidate being a parking space, based on the surrounding images and predefined criteria, wherein
the criteria include at least one criterion with respect to a shape or position of the parking space candidate detected in the surrounding images, and at least one criterion with respect to an indicator or object present around the parking space candidate.

11. A computer program product comprising a non-transitory computer readable storage medium having a computer readable program embodied therewith, the computer readable program configured to cause a computer to perform a method for determining a parking space, the method comprising:
acquiring surrounding images that are images of surroundings of a host vehicle;
detecting, from the surrounding images, a parking space candidate (PS) that is an area likely to be a parking space; and
determining whether the parking space candidate is a parking space and a likelihood of the parking space candidate being a parking space, based on the surrounding images and predefined criteria, wherein
the criteria include at least one criterion with respect to a shape or position of the parking space candidate detected in the surrounding images, and at least one criterion with respect to an indicator or object present around the parking space candidate.
